(19) United States
(12) Patent Application Publication
(10) Pub. No.: US 2015/0360641 A1
(43) Pub. Date: Dec. 17, 2015

(54) BELT BUCKLE PRESENTER FOR A SAFETY BELT OF A VEHICLE

(71) Applicant: DAIMLER AG, Stuttgart (DE)

(72) Inventor: Juergen WARWEL, Stuttgart (DE)

(73) Assignee: DAIMLER AG, Stuttgart (DE)

(21) Appl. No.: 14/762,766

(22) PCT Filed: Dec. 11, 2013
(86) PCT No.: PCT/EP2013/003745

§ 371 Date: Jul. 22, 2015

(30) Foreign Application Priority Data
Jan. 23, 2013 (DE) 10 2013 001 030.6

(51) Int. Cl. B60R 22/03; B60R 22/26; B60R 22/20

(52) U.S. Cl. CPC B60R 22/03; B60R 22/20; B60R 22/26; B60R 2022/1806

(57) ABSTRACT

A belt buckle presenter for a safety belt of a vehicle is disclosed. The belt buckle presenter includes at least one belt buckle which is connected to a drive unit via a force transmission element. The belt buckle is able to be moved between an operating position and a presenting position. The force transmission element is formed as a roller chain and a movement direction of the belt buckle during driving is able to be provided by a guide element.

### BACKGROUND AND SUMMARY OF THE INVENTION

The invention relates to a belt buckle presenter for a safety belt of a vehicle which comprises at least one belt buckle which is connected to a drive unit via a force transmission element, wherein the belt buckle is able to be moved between an operating position and a presenting position.

A positioning device, in particular for positioning a belt buckle or a safety belt in a motor vehicle, is known from DE 10 2008 026 872 A1. The positioning device comprises a deformable, load-bearing element, a molded part coupled to the load-bearing element and a holder. The load-bearing element is able to be displaced from a first position in which the molded part is held in a first form by the holder, into a second position in which the molded part is at least partially no longer held by the holder and assumes a second form which is transmitted to the load-bearing element.

Furthermore, a belt buckle presenter for a vehicle is known from DE 10 2011 008 779 A1. The belt buckle presenter comprises a drive unit coupled to an adjustment mechanism, by means of which a belt buckle is able to be moved at least between an initial position and a presenting position. Here, the drive unit is arranged to be spatially separated from the adjustment mechanism on or in the vehicle.

Concerning this, DE 10 2011 011 780 A1 discloses a belt buckle presenter for a safety belt system of a vehicle having a belt buckle which is coupled to a spindle drive via a force transmission means. The force transmission means has a locking element which is able to move in a standard operation along a threaded spindle of the spindle drive in the axial direction and can be deformed in the case of restraint by a restraining force acting on the belt buckle in order to occupy a locking position in which the locking element engages with the threaded spindle in a positive manner.

The object of the invention is to specify an improved belt buckle presenter for a safety belt of a vehicle compared to prior art.

A belt buckle presenter for a safety belt of a vehicle comprises at least one belt buckle which is connected to a drive unit via a force transmission element, wherein the belt buckle is able to be moved between an operating position and a presenting position. According to the invention, the force transmission element is formed as a roller chain and a movement direction of the belt buckle during driving is able to be provided by means of a guide element.

By means of the roller chain as a force transmission element, it is possible, in a particularly advantageous manner, to guide the belt buckle linearly in the case of a spatially-limited, available construction space, i.e., between the operating position and the presenting position. Such a roller chain has a comparably low deflection radius, such that the belt buckle can be actively extended despite the limited construction space. In particular, the belt buckle presenter is arranged in a rear seat region of the vehicle, wherein conditions prescribed by means of the described solution with respect to an implementation and arrangement of the belt buckle presenter in connection with the safety belt of the vehicle are fulfilled.

The roller chain interacts with the guide element which provides the movement direction of the belt buckle during driving. The belt buckle is able to be guided in a particularly advantageous manner, reliably and in a controlled manner, between the operating position and the presenting position, in particular is able to be guided linearly by means of the guide element.

Due to the fact that the movement direction is provided by means of the guide element, it is possible in a particularly advantageous manner to move the belt buckle between the two positions in such a way that the belt buckle does not rub against the upholstered surfaces and thus the upholstery or the cover thereof is not damaged.

During use of a belt buckle presenter formed in this way, it is additionally not required to change the belt buckle itself with regard to its dimensions, as both the guide element and the roller chain have a low construction space requirement due to their comparably low deflecting radius.

In an advantageous embodiment, the roller chain and the guide element are arranged in a housing, such that an entry of dirt is able to be eliminated as far as possible, in particular into the roller chain. Additionally, the roller chain and the guide element are covered by means of a housing and thus are not visible.

The use of a thus formed belt buckle presenter is also conceivable for front vehicle seats.

In a preferred embodiment, the guide element is fixed on the belt buckle and a bearing vehicle structure and/or seat structure, such that restraint forces of a safety belt coupled to the belt buckle which occur in the case of restraint are able to be introduced into the vehicle structure and/or the seat structure in an advantageous manner. Particularly preferably, the guide element is formed and is fixed to the belt buckle and the bearing vehicle structure and/or seat structure in such a way that the belt buckle is flexible laterally. Using this provided flexibility, it is possible, for example, that the belt buckle fits closely to a vehicle passenger to whom the safety belt is allocated in the case of the designed safety belt. Furthermore, a seat back can be folded without the belt buckle limiting this folding procedure.

Preferably, the roller chain is fixed to the belt buckle and to a carrier which is arranged displaceably on a guide rail, such that a number of parts of the belt buckle presenter is comparably low. Advantageously, the roller chain is fixed both to the belt buckle and to the carrier in a non-positive, positive and/or firmly bonded manner, whereby the roller chain is held on the respective component.

In a further preferred embodiment, the roller chain is able to be guided by means of a bearing element, whereby, on the one hand, the roller chain is able to be positioned and, on the other hand, a direction in which the roller chain moves during movement of the belt buckle is able to be provided. A symmetrical construction and an optimum chain guiding during a rotation of the roller chain around the bearing element are able to be implemented by means of the bearing element.

Particularly advantageously, the bearing element is formed as a bearing bush, through which the roller chain is able to pass. The bearing bush is therefore circumferentially closed and has a through-hole, the axis of which is arranged in the running direction of the roller chain in this section. The positioning and the alignment of the roller chain can be substantially ensured by means of the bearing bush.

The bearing element is fixed to the bearing vehicle structure and/or to the seat structure, such that forces acting on the roller chain are able to be introduced into the bearing vehicle structure and/or the seat structure.

It can advantageously be provided that the bearing element is formed in such a way that the guide element is fixed on the bearing vehicle structure and/or the seat structure to provide the movement direction during driving of the belt buckle by means of the bearing element.

In a particularly preferred embodiment, the roller chain is formed as a rigid-backed roller chain which is suitable in particular for the transfer of compressive and tensile forces. Thus, large distances are able to be bridged by means of such a rigid-backed roller chain without an obligatorily required chain guide. Such a rigid-backed roller chain has a similar function as a linear drive, whereby it is possible that the belt buckle can implement a linear movement between the operating position and the presenting position.

In an advantageous manner, the drive unit is formed as a spindle drive, whereby the carrier arranged on the guide rail is able to be displaced linearly on this and, as the roller chain is coupled to the carrier, this movement is able to be transmitted to the roller chain, whereby the belt buckle is able to be moved between the two positions.

In a further particularly preferred embodiment, the belt buckle having the roller chain is mounted to be able to pivot around a rotational axis which runs perpendicularly to the longitudinal expansion of the belt buckle. Thus it is possible to pivot the belt buckle, in particular during folding of the seat back.

Exemplary embodiments of the invention are illustrated in greater detail below by means of drawings.

### BRIEF DESCRIPTION OF THE DRAWINGS

FIG. 1 shows schematically a perspective view of a belt buckle presenter in an operating position,

FIG. 2 shows schematically a side view of the belt buckle presenter in the operating position,

FIG. 3 shows schematically a top view of the belt buckle presenter in the operating position,

FIG. 4 shows schematically a further side view of the belt buckle presenter in the operating position,

FIG. 5 shows schematically a perspective view of the belt buckle presenter in a presenting position,

FIG. 6 shows schematically a side view of the belt buckle presenter in the presenting position,

FIG. 7 shows schematically the perspective view according to FIG. 5 without a bearing element,

FIG. 8 shows schematically a perspective depiction of the belt buckle presenter in the presenting position in a first partially assembled state, and

FIG. 9 shows schematically a perspective view of the belt buckle presenter in the presenting position in a second partially assembled state.

### DETAILED DESCRIPTION OF THE DRAWINGS

Parts that correspond to one another are provided with the same reference numerals in all figures.

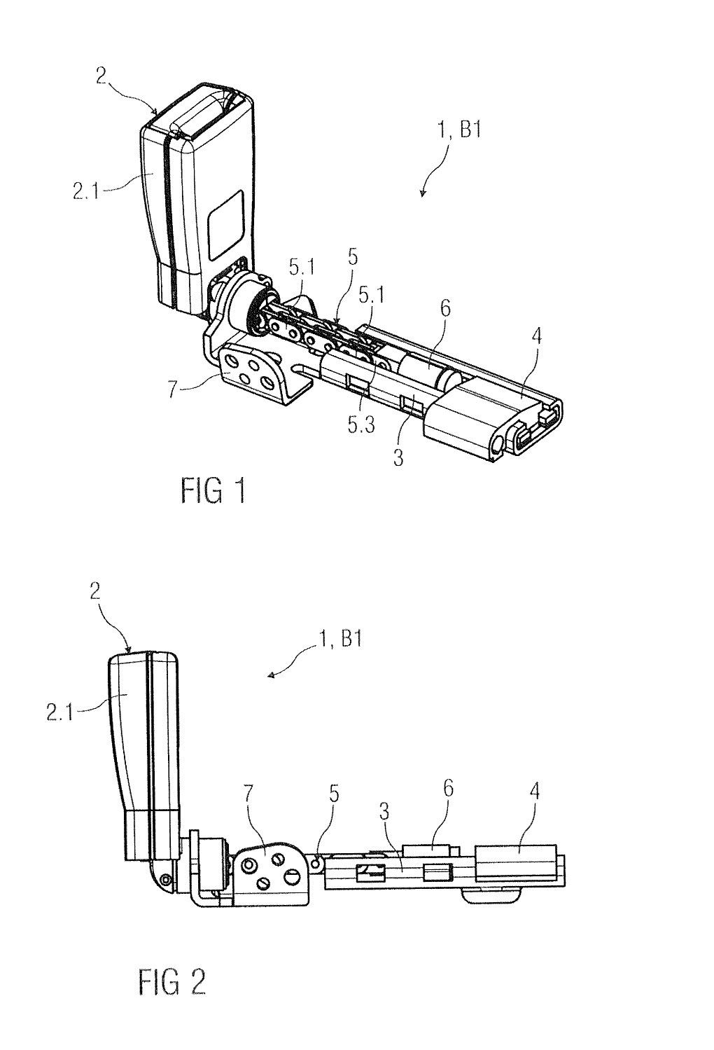

FIG. 1 shows a perspective view of a belt buckle presenter 1 for a vehicle which is not depicted in greater detail, wherein the belt buckle presenter 1 is provided in particular for seats in the rear region of the vehicle.

The belt buckle presenter 1 has a belt buckle 2 which is able to be moved between an operating position B1 and a presenting position B2 by means of the belt buckle presenter 1. If, for example, it is detected that a vehicle door is closed and/or that a vehicle passenger has sat down on a vehicle seat, the belt buckle 2 is positioned automatically from the operating position B1, which also represents an initial position, into the presenting position B2, which is also referred to as a comfort position, by means of the belt buckle presenter 1. In the presenting position B2, a vehicle passenger can set up a safety belt allocated to the belt buckle 2 and insert a belt buckle tongue arranged on the belt strap into the belt buckle 2.

In particular, the belt buckle 2 is situated in the presenting position B2 in a position which is easily accessible for the vehicle passenger, such that the vehicle passenger can insert the belt buckle tongue into the belt buckle 2 without a great effort.

In comparison to the operating position B1, the belt buckle 2 is situated in a higher position in the presenting position B2. If the belt buckle tongue is inserted into the belt buckle 2, the belt buckle tongue is locked in place within the belt buckle 2 and is automatically moved into and positioned in the operating position B1.

In particular, the belt buckle presenter 1 is provided, in the present exemplary embodiment according to FIG. 1, as is described above, for a seat in the rear region of the vehicle, wherein the belt buckle 2 is arranged or can be arranged in the operating position B1, which at the same time forms the initial position, between the upholstery of the rear seats.

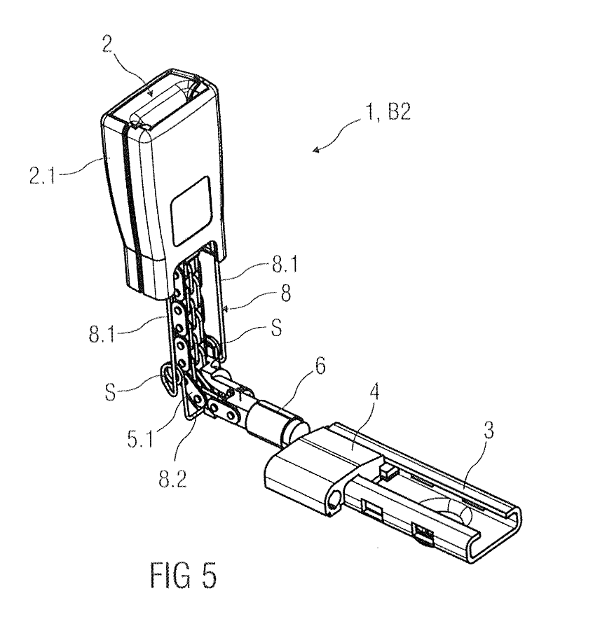

The belt buckle presenter 1 furthermore has a drive unit, which is not shown, in the form of a spindle drive, a guide rail 3 on which a carrier 4 is arranged to be displaceable, a holding element 6 which is connected both to the carrier 4 and to a roller chain 5, a bearing element 7 and a guide element 8 which is depicted in particular in FIG. 5.

In order to be able to guide the movement of the belt buckle 2 in a controlled manner, in particular with regard to the movement direction, the guide element 8 is provided which is fixed on the one side to the belt buckle 2 and on the other side indirectly or directly to a bearing vehicle structure, in particular a base sheet of the motor vehicle and/or to a seat structure in the rear seat region.

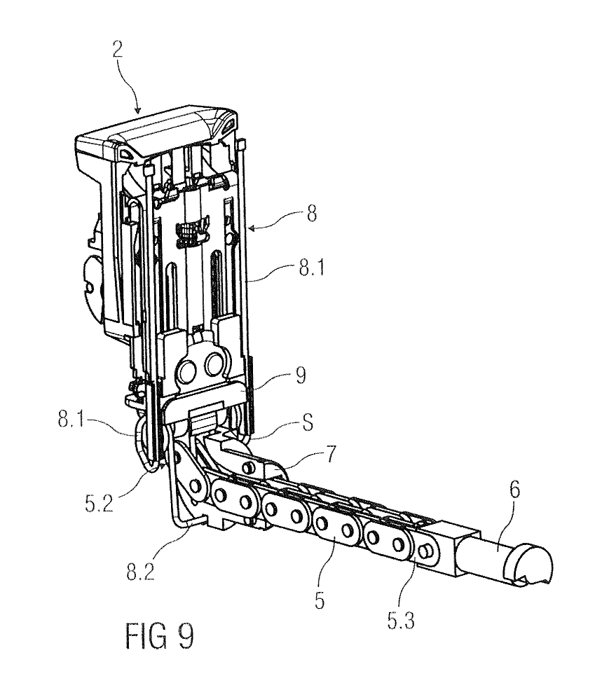

In FIG. 1, the belt buckle 2 is situated in the operating position B1, wherein the guide element 8 is inserted substantially completely into the belt buckle 2. The guide element 8 is formed from a spring steel and has a U-shape, wherein free ends of the legs 8.1 depicted in FIG. 9 are formed to be thickened and/or widened. For example, the ends are steamed, whereby these widen. The ends are arranged within a housing 2.1 of the belt buckle 2. The respective leg 8.1 is formed in a spiral shape in one section in the direction of a bar 8.2 which connects the legs 8.1, such that this section forms a leg spring S. Thus, the respective spring axis is arranged perpendicularly to the course of the legs 8.1, wherein the spring axis of both leg springs S are arranged on one axis.

Due to the fact that guide element 8 is formed to be U-shaped, this is able to receive tolerances elastically during the controlled guiding of the belt buckle 2 and during occurring torques in the operation of the belt buckle presenter 1.

If the belt buckle 2 is situated in the operating position B1, as is shown in FIGS. 1 to 4, then the spiral-shaped sections of the guide element 8 which form the leg springs S are arranged within the belt buckle 2.

The guide element 8 is fixed inside the housing 2.1 of the belt buckle 2 by means of a fixing element 9 which is also depicted in greater detail in FIG. 9, wherein the fixing element 9 is preferably formed from a plastic which has a comparably high sliding capability. If the plastic from which the belt buckle 2, in particular the housing 2.1 thereof, is formed has this property, then the fixing element 9 can be formed from this plastic. If this plastic does not have sufficient sliding capability, the fixing element 9 is formed from another plastic which has sliding capability. If a separate material pair is not required, then the fixing element 9 with its function can be integrated constructively directly into the housing 2.1 which is formed by means of housing shells, such that the fixing element 9 is not formed as a separate part.

As is described above, the movement direction of the belt buckle 2 during driving of the same between the two positions B1, B2 is able to be provided by means of the guide element 8.

To move the belt buckle 2 which is situated in the operating position B1, so in the initial position, the drive unit is activated which comprises a drive shaft which is connected to the drive unit, a gear, a spindle and the carrier 4 which is arranged on the guide rail 3. The drive unit is fixed in position in the vehicle and drives the spindle such that this rotates.

Due to the rotational movement of the spindle, the carrier 4 moves upwards or downwards on the spindle and on the guide rail 3, whereby the belt buckle 2 is able to be positioned. For this purpose, the belt buckle 2 is connected to the carrier 4 via a force transmission element which is formed as the roller chain 5, such that the belt buckle 2 moves during movement of the carrier 4 on the spindle and the guide rail 3 and moves between the operating position B1 and the presenting position B2.

The roller chain 5 consists of a predetermined number of chain links 5.1, wherein a first end 5.2 shown in FIG. 9 is fixed to the fixing element 9 which is arranged in the housing 2.1 of the belt buckle 2. The holding element 6 is arranged on an opposing second end 5.3, via which the roller chain 5 is connected to the carrier 4.

The bearing element, which is formed as a bearing bush and has a through-hole, is situated in a region between the belt buckle 2 and the guiding chain 3. The roller chain 5 is guided through the through-hole such that the bearing element 7 forms a chain guide for the roller chain 5.

The bearing element 7 is formed to be flange-like and has a number of recesses to receive connection elements which are not shown, for example screws, by means of which the bearing element 7 is able to be fixed on the bearing vehicle structure and/or the seat structure.

Additionally, the bearing element 7 preferably forms a fixing point for the guide element 8, such that this is able to be fixed to the bearing vehicle structure and/or the seat structure by means of the bearing element 7. For example a channel-shaped recess is formed in the bearing element 7 in which the bar 8.2 is able to be arranged and is able to be fixed in a preferably firmly bonded manner.

The roller chain 5 is a rigid-backed roller chain 5 which is flexible on one side and can bridge distances without necessary elements for chain guiding. The belt buckle 2 is able to be moved by means of the propulsive and tensile force transmitted to the roller chain 5 and is able to be positioned in the operating position B1 or the presenting position B2.

The roller chain 5 is substantially straight in the operating position B1 of the belt buckle 2, wherein the longitudinal axis of the chain links 5.1 are substantially aligned in one direction. Here, the carrier 4 is situated on a side opposing the belt buckle 2 on the guide rail 3 such that the holding element 6 and a section of the roller chain 5 which borders the same are arranged within the guide rail 3.

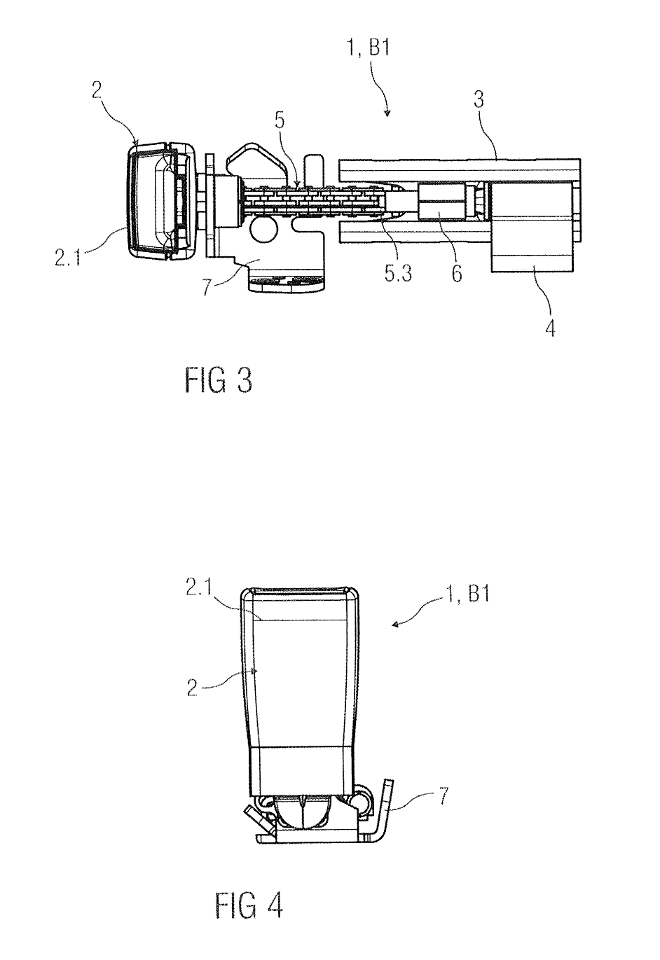

FIGS. 2 to 4 also show the belt buckle 2 in the operating position B1, wherein the belt buckle presenter 1 is depicted in FIG. 2 in a first side view, in FIG. 3 in a top view and in FIG. 4 in a second side view.

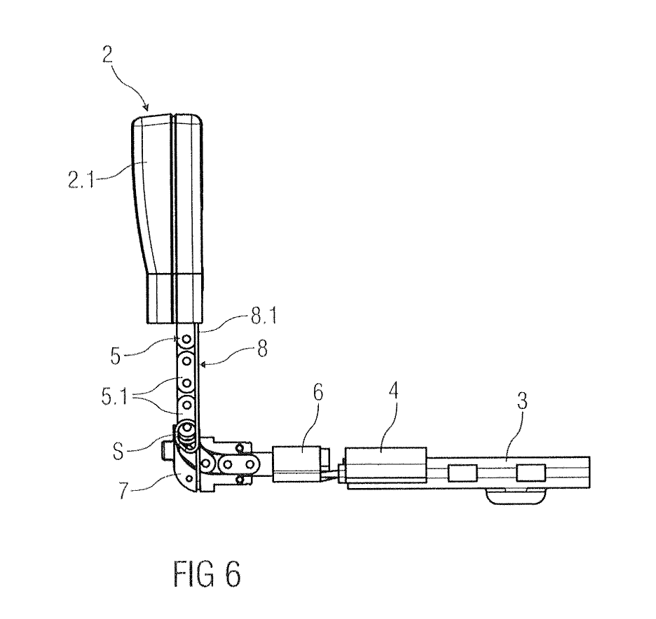

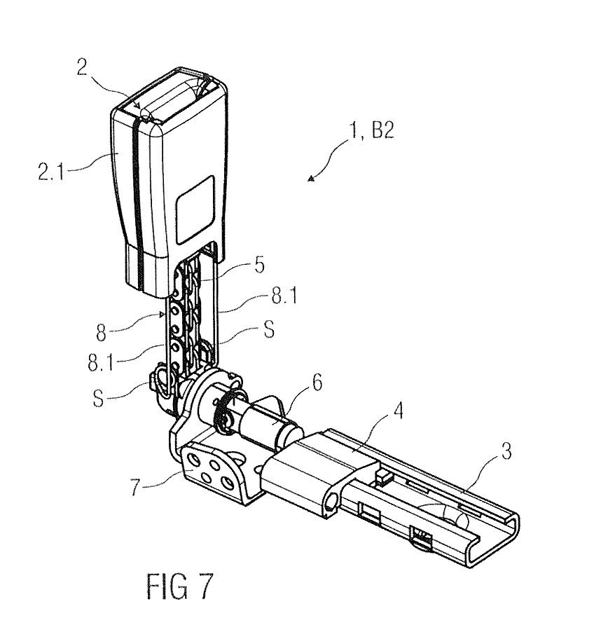

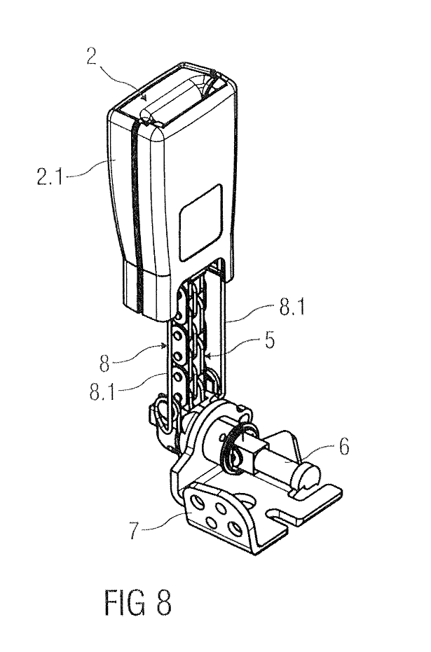

The drive unit is activated such that the carrier 4 moves along the guide rail 3 and thus a propulsive force is exerted on the roller chain 5. The belt buckle 2 is connected both to the guide element 8 and to the roller chain 5, such that this is deflected on the bearing element 7 in the direction of the belt buckle 2, as is shown in greater detail in FIGS. 5 to 8. Therein, FIG. 5 shows the belt buckle presenter 1 in a perspective view and in FIG. 6 in a side view. In FIG. 7, the belt buckle presenter 1 is shown in a perspective view without the bearing element 7 and in FIG. 8 without the carrier 4 and the guide rail 3. Therein, the belt buckle 2 is depicted in FIGS. 5 to 8 in the presenting position B2.

The roller chain 5 displaces the belt buckle 2 from the operating position B1 into the presenting position B2, wherein the movement direction of the belt buckle 2 is provided by means of the guide element 8. The more tensile force the roller chain 5 exerts on the belt buckle 2, the more the guide element 8 is displaced from the housing 2.1 of the belt buckle 2.

In a possible alternative, the presenting position B2 of the belt buckle 2 is reached if the holding element 6 strikes the bearing element 7 between roller chain 5 and carrier 4.

In a further possible alternative, the method ends in presenting position B2 if the guide element 8 is displaced completely from the housing 2.1 of the belt buckle 2.

FIG. 9 shows a perspective view of the belt buckle presenter 1, wherein the belt buckle 2 is situated in an intermediate position and the guide element 8 is thus displaced only partially from the housing 2.1 of the belt buckle 2 which is not depicted. Additionally, the guide rail 3 and the carrier 4 are not depicted and the bearing element 7 is shown in a cross-sectional depiction.

1.-10. (canceled)

11. A belt buckle presenter for a safety belt of a vehicle, comprising:
a belt buckle which is connected to a drive unit via a force transmission element, wherein the belt buckle is movable between an operating position and a presenting position;
wherein the force transmission element is a roller chain and wherein a movement direction of the belt buckle during driving is guidable by a guide element.

12. The belt buckle presenter according to claim 11, wherein the guide element is fixed to the belt buckle and a bearing vehicle structure and/or a seat structure.

13. The belt buckle presenter according to claim 11, wherein the roller chain is fixed to the belt buckle and to a carrier which is arranged displaceably on a guide rail.

14. The belt buckle presenter according to claim 11, wherein the roller chain is guidable by a bearing element.

15. The belt buckle presenter according claim 14, wherein the bearing element is a bearing bush through which the roller chain is guidable.

16. The belt buckle presenter according to claim 14, wherein the bearing element is fixed on a bearing vehicle structure and/or a seat structure.

17. The belt buckle presenter according to claim 11, wherein the roller chain is a rigid-backed roller chain.

18. The belt buckle presenter according to claim 11, wherein the drive unit is a spindle drive.

19. The belt buckle presenter according to claim 11, wherein the belt buckle is pivotable around a rotational axis which runs perpendicularly to a longitudinal expansion of the belt buckle.

20. The belt buckle presenter according to claim 11, wherein the belt buckle presenter is disposed in a rear seat region of the vehicle.
